(19) United States
(12) Patent Application Publication
(10) Pub. No.: US 2019/0153269 A1
(43) Pub. Date: May 23, 2019

(54) Method of Texturing and Article of Manufacture

(71) Applicant: Andrea Lucas, Irondale, AL (US)

(72) Inventor: Andrea Lucas, Irondale, AL (US)

(21) Appl. No.: 15/820,159

(22) Filed: Nov. 21, 2017

(51) Int. Cl. C09J 9/00; C09D 175/04; C09J 5/00; B05D 1/18; B05D 3/00

(52) U.S. Cl. CPC C09J 9/005; C09D 175/04; C09J 2201/61; B05D 1/18; B05D 3/007; C09J 5/00

(57) ABSTRACT

A method for texturing and applying a decorative finish to an article or other surface comprising application of a texture of hot melt adhesive to an article such that the texture mimics melted candle wax drippings that have adhered to the outer surface of a candle as the melted wax was running down the candle and dried during its path downward. At least one coating of paint is applied to the article and at least one coating of urethane is applied to said article.

### CROSS-REFERENCED TO RELATED APPLICATIONS

None

### FEDERALLY SPONSORED RESEARCH

None

### SEQUENCE LISTING

None

### FIELD OF THE INVENTION

The invention relates to method for forming a textured and decorative article. Specifically, the article can be any number of articles that exist in the art such as a walking stick or cane, a broom handle, a shovel handle, a rake handle, a kitchen utensil and many other items.

### BACKGROUND OF THE INVENTION

There are various forms of painting and texturing articles in the prior art. However, there is not known in the prior art a method for applying a unique texture and multi-color coating onto an article that mimics the outer surface of a candle that has had hot wax drippings solidify on it's outer surface after a portion of the candle has burned. Additionally, the texture as applied allows for enhanced gripping of the article due to creating a frictional advantage between the article and a user's hands. Further, the texture along with coatings of paint and urethane enhance the strength, rigidity, and abrasion resistance of the article. The present invention provides a method whereby a creator can apply a texture to an article that mimics wax drippings as well as a multi-color attractive coating.

### SUMMARY OF THE INVENTION

The invention is a method for applying a unique texture and multi-color coating to an outer surface of an article. Additionally, a variety of elongated articles are particularly well suited to this method of texturing and coating. Some examples are walking sticks, walking canes, shovels, rakes, lampposts among many others and more fully described below. At least one anchor point located in an upper surface such as a ceiling, joist, beam, rafter or a dedicated suspension rack is employed in the method. A filament is attached to the anchor point on its upper end and an elongate article is attached or tied to the bottom end of the filament such that the elongate article is suspended above the ground and at a level appropriate for an creator to perform the method. Once the elongate article is suspended above ground, a texture is applied to the article using hot glue sticks and a hot glue gun. Hot glue is applied in a desired quantity onto the outer surface of the article by the creator while they simultaneously rotate the article. This can be done multiple times to ensure the desired thickness and appearance of the candle wax drip effect. Additionally, a creator can apply wood putty in desired locations in addition to the hot glue to obtain a desired effect.

Once the candle wax drip effect is deemed suitable by the creator and has dried and cured, the elongate article is rubbed down to remove any loose glue particles or strands. The creator will then apply a base coat or a first coat of paint to the article on top of the hot glue textured surface and then allow it to dry. The base coat in a preferred embodiment is selected from a group of light shaded solid colors. The base coat can in the case of an elongated article be applied by dipping the article into a vat that contains the desired color paint. A further step can be employed whereby a paint dispensing device such as those commonly used in baking goods decoration is loaded with acrylic paint such that different colors are loaded as generally layers of paint in a cylindrical container. The colors can be loaded strategically in layers to take advantage of the color mixing properties of different pigmented paints to reveal secondary and tertiary colors. If a variety of colors are used in the paint dispenser, mixing of the paint occurs as the paint is applied and drips downward revealing various hues of color and also interacting with the first coat of paint such that where the newly applied paint does not cover the first coat, the first coat is displayed further enhancing the effect. An creator will apply paint until the article is covered. A drying period of three to five days is usually required depending upon whether the creator is satisfied with the effect of color mixing in the paint or whether another coating is applied. Finally, when the paint on the article has dried, the article will be coated with at least one coat of urethane. In a preferred embodiment, at least three coats of urethane is desired to give the article a strong protective coating. This is done either by spraying or applying the urethane by brush, or by pouring the urethane in a vat and dipping the elongate article into the vat on one end first, letting the article dry and reversing the article and dipping the opposite end into the vat. The urethane coating not only protects the paint but it creates a strong exoskeleton on the article such that it gives the article more rigidity and strength taking advantage of the numerous texture folds in the textured surface such that it creates a matrix that enhances the strength of the article.

Specific advantages and features of the present assembly will be apparent from the accompanying drawings and the description of several illustrative embodiments of the present invention.

### BRIEF DESCRIPTION OF THE DRAWINGS

FIG. 1 is a perspective view of an article having the disclosed textured surface.

FIG. 2 shows a perspective view of one embodiment of anchor points and filaments used to suspend an elongate article.

FIG. 3 shows a perspective view of the creator texturing the article with hot glue.

FIG. 4 shows a perspective view of the creator texturing the article with paint.

FIG. 5 shows a perspective view of the creator applying a protective coating.

### DETAILED DESCRIPTION

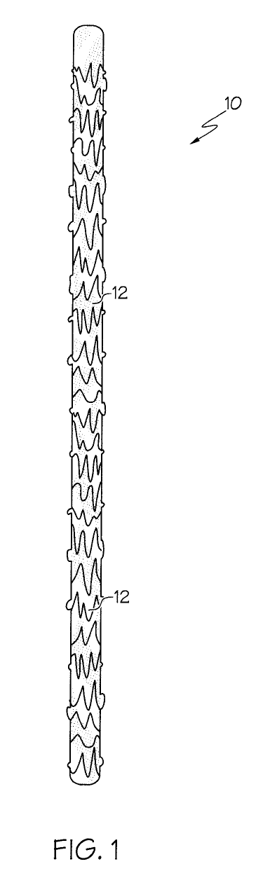

The invention is generally depicted in FIGS. 1-5 but may be embodied in various other forms. The principles and teachings of the invention, therefore, can be applied to numerous alternative variations.

Referring now to FIGS. 1-5, there are shown a number of views of a process for texturing an article 10 such that the surface of the article looks like melted dripped candle wax on the outer surface of a partially burned candle. An unlimited number of different articles can be the recipient of this process of texturing and coating. Some examples of said articles are walking sticks, walking canes, shovels, rakes, hoes, hammers, axes, lamp stands lampposts, lamp shades, wooden furniture, furniture legs, pencils, pens, kitchen utensils, and picture frames among many other examples of articles of manufacture. In addition, walls of a room can be the recipient of the process. For wooden walking sticks that are sourced directly from nature in the forest or field, there are some additional steps required to prepare them for the texturing process. The sticks are cut to desired lengths, a length of bark is sanded off of each end of the stick, and each end of the stick is dipped into melted paraffin wax. This step prevents the ends of the sticks from splitting as they are subjected to a drying process that can take upwards of a year to complete.

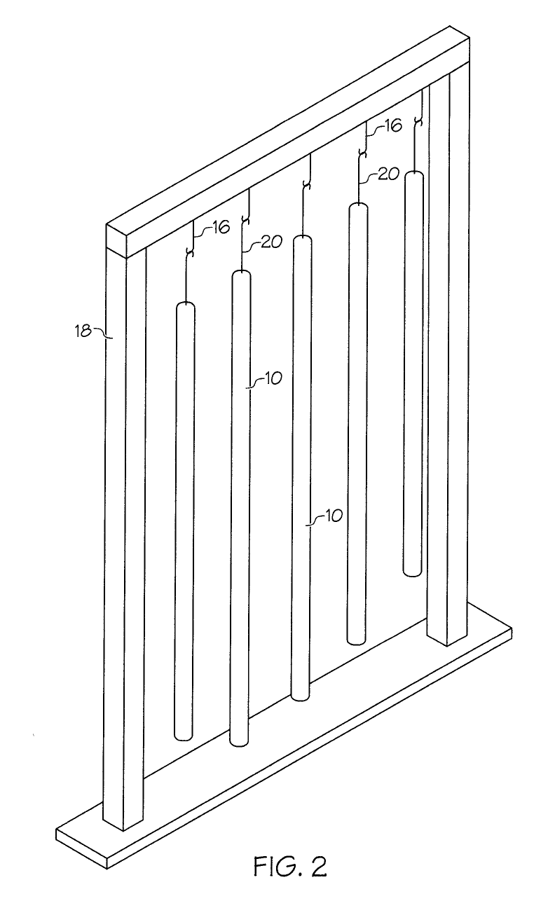

For a number of articles 10 that are generally elongate in shape, at least one anchor point 16 would be employed to suspend the article 10 at a desired height relative to a creator 8 by use of a filament 20 that could be made of a variety of materials such as fibrous cords, synthetic filaments such as fishing line, metal and other similar substances of adequate strength and flexibility. The filament 20 would be attached to the anchor point 16 and then to one end of an article 10. At least one anchor point 16 located in an upper surface such as a ceiling, joist, beam, rafter or a dedicated suspension rack 18 as shown in FIG. 2 is employed in the method. Means for suspension of the article 10 can include a number of different solutions. Anchor points such as threaded eye loop or threaded S hooks can be installed into an upper ceiling, beam, rafter, suspension rack 18 or other solid surface such that a filament 20 can be attached thereto and extend downwards where it can be fastened to the article 10. Additionally, a filament 20 can be tied directly to a suspended beam such that it extends downward where a creator can attach the article to the filament. A device with a swivel may also be attached to the end of filament 20 such that it allows the user to rotate the article 10 without building up tension in the filament 20 such that when a user releases the article 10, it does not violently spin and alter the applied texture or paint in an unwanted manner. The ability to rotate the article 10 allows for easy application of the texture to the article by the creator. It also aids in applying the texture in a uniform fashion by rotating the article 10 with one hand and applying hot melt adhesive with a glue gun in the other hand. A filament 20 is attached to the anchor point 16 on its upper end and an elongated article 10 is attached or tied to the bottom end of the filament 20 such that the elongate article 10 is suspended above the ground and at a level appropriate for a creator 8 to perform the method. The filament 20 allows a creator to support the article 10 while simultaneously rotating the article 10 while they apply a texture 12 such that the creator does not have to simultaneously support the article 10 and rotate it. Once the elongate article 10 is suspended above ground, a texture 12 is applied.

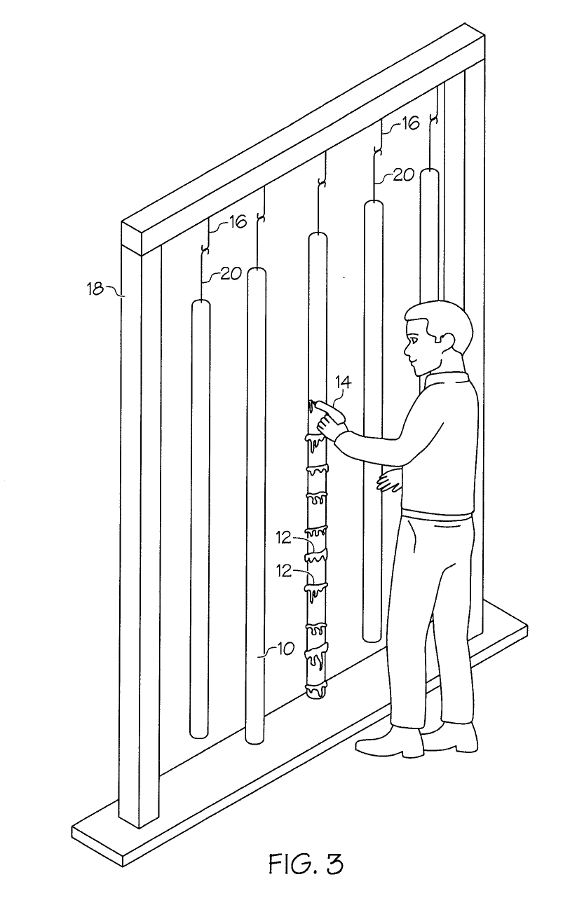

The texture 12 is a hot melt adhesive commonly referred to as hot glue, and used interchangeably herein, and is applied via use of a hot glue gun 14 using hot glue sticks. The hot glue texture is applied in a desired quantity onto the outer surface of the article 10 as shown in FIG. 3 in small up and down motions of the glue gun by the creator while the creator simultaneously rotates the article 10. The creator will apply the texture 12 to the article 10 going from the bottom to the top of the article 10. This provides the desired dripping candle wax effect texture 12 of the hot glue onto the surface of the article 10. This step can be performed multiple times to achieve the desired thickness and appearance of the candle wax drip effect. To add additional effects to the texture 12, the hot glue gun temperature can be adjusted to hotter or cooler which produces a different looking result with the texture 12. When a section of the article has had hot glue applied to it after rotation, the creator will let it dry before adding an additional texture of hot glue in the above described fashion. Additionally, a creator can apply wood putty in desired locations on the article in addition to the hot glue to obtain a desired texture effect.

Once the candle wax drip effect texture 12 is achieved by the creator and has dried and cured, the article 10 is rubbed down and in some cases the article 10 is sanded to remove any loose glue particles or strands. The creator will then apply a first coat of paint to the article on top of the hot melt adhesive textured surface 12 and then allow it to dry. The first coat of paint is a single light color chosen by the creator based on the end product they envision. A further step can be employed whereby a paint dispenser 24 such as those commonly used in baking goods decoration is loaded with acrylic paint such that different colors of paint are loaded as generally layers of paint in a cylindrical container of the paint dispenser 24. The paint colors are loaded strategically in layers to take advantage of the color mixing properties of different pigmented paints to create secondary and tertiary colors once they mix as applied to the article 10. The paint used in the process should be of a sufficient viscosity that it runs very slowly or spreads downward very slowly due to gravity.

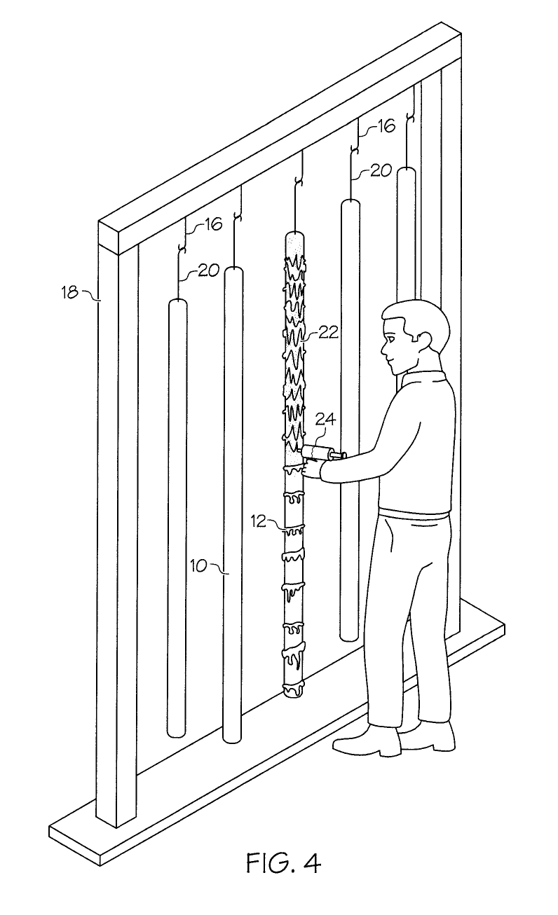

As shown in FIG. 4, the paint is applied to the article 10 starting from the top of the article 10 and incrementally moving downwards while the creator simultaneously rotates the article 10 via their opposite hand via the filament 20 and the anchor point 16. The paint conforms to the textured surface 12 of the article 10 and adds additional texture in conformity with the hot glue texture 12 such that it runs down via gravity a certain length of the article 10. If a variety of colors are used in the in the paint dispenser 24, mixing of the paint occurs as the paint is applied and drips downward revealing various hues of color and also interacts with the first coat of paint such that where the newly applied paint does not cover the first coat, the first coat is displayed further enhancing the effect. A creator will apply paint until the article 10 is covered. A drying period of three to five days is usually required depending upon whether the creator is satisfied with the effect of color mixing in the paint or whether another coating of paint is applied. The drying period is three days for an earlier applied coat of paint if the creator is going to apply additional coats. If the paint as applied is not suitable in appearance to the creator, the creator can lightly abrade or sand the surface of the paint on the article 10 with steel wool or fine sand paper to further prepare the article for a new paint coating to be applied. After applying the final coating of paint, the article 10 is set to dry and bake out under the sun for a desired length of time. In one embodiment of the method, three days is the amount of time the articles are left to dry in the sun. An alternate step for achieving a desired paint look involves the step of the creator lifting the article 10 to a diagonal or horizontal position directly after applying paint and rotating said article 10 such that the applied paint runs in a diagonal to horizontal direction on the surface of the article to create a desired effect.

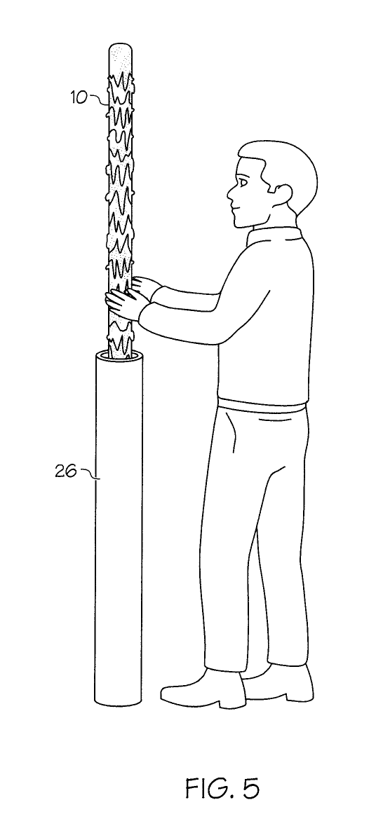

When the paint on the article 10 has completely dried, the article 10 will be coated with at least one coat of urethane. In a preferred embodiment, at least three coatings of urethane is optimal, and spar urethane is the preferred type of urethane used to coat the article 10. This can be done either by spraying or applying the urethane onto the article and also, for an article 10 that is elongated in shape, a preferred method of applying the urethane is by dipping the elongated article 10 into a vat 26 as shown in FIG. 5 on one end first, retrieving the article 10 out of the vat 26, putting it to rest in a urethane retrieval vessel that collects excess urethane and then hanging the article to dry overnight. The article 10 is next dipped into the vat 26 on its other end. It is retrieved out of the vat 26, inserted to rest in a urethane retrieval vessel that collects excess urethane and then hung to dry overnight. The vat 26 contains the urethane and must be mixed from time to time with a mixing device 28 to achieve a uniform consistency of urethane in the vat 26 that is necessary for coating an article 10. The urethane coating not only protects the paint but it creates a strong exoskeleton on the article 10 such that it gives the article 10 more rigidity, strength, and abrasive resistance by taking advantage of the numerous texture folds in the textured surface such that it creates a matrix that enhances the strength of the article. Additional coats of urethane enhance this strength and durability of the article 10 in addition to protecting the texture 12 and paint finish. After each coat of urethane, the article is sanded to prepare it for additional coats until the final coat is achieved. In a preferred embodiment, there are at least four coatings of spar urethane applied to the article.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

### ELEMENTS

10 article
12 texture
14 hot glue gun
16 Anchor point
18 suspension rack
20 filament
22 paint
24 Paint dispenser
26 vat
28 Mixing device

What I claim is:

1. A method for texturing an article of manufacture, comprising the steps of:
providing an article of manufacture; and
applying texture to an outer surface of the article of manufacture wherein the texture is a hot melt adhesive that is applied using a hot glue gun such that the texture dries on the outer surface of the article and mimics dripped candle wax that has adhered to the outer surface of a candle.

2. The method of claim 1 whereby the texture is applied to the article by a creator using small horizontal and vertical movements with a hot glue gun to mimic dripped candle wax.

3. The method of claim 1 whereby additional texture of hot melt adhesive are applied to the article once a previous coating has dried.

4. The method of claim 3 further comprising the step whereby the texture is rubbed down after application and drying.

5. The method of claim 1 further comprising the step whereby putty is strategically placed onto the texture to further enhance and mimic dripped candle wax.

6. The method of claim 1 further comprising the step of applying a coating of paint to the texture and article.

7. The method of claim 6 further comprising the step of loading a paint dispenser with various colors of paints such that the various colors of paint are added in layers on top of each other in a strategic fashion to get a desired blending of said paint colors into new colors and applying application said paint to said texture on said article.

8. The method of claim 7 further comprising the step of letting the painted article dry for a time period of three to five days after a coating of paint is applied and repeating the step of claim 7 as many times as desired by a creator to obtain a desired look.

9. The method of claim 8 further comprising the step of placing the article in the sun for at least three days to fully dry after a final coating of paint has been applied.

10. The method of claim 9 further comprising the step of applying a first coat of urethane to the texture and article and allowing said article to dry between any optional additional coating of urethane.

11. A method for texturing an article of manufacture, comprising the steps of:
providing an article of manufacture that is elongated in shape;
providing means of suspension of said article such that it is positioned above the ground at a height whereby a creator can reach the article and said means of suspension allow for easy rotation of the article while it is suspended;
applying a texture to an outer surface of the article of manufacture wherein the texture is a hot melt adhesive that is applied using a hot glue gun such that the texture dries on the outer surface of the article and mimics dripped candle wax that has adhered to the outer surface of a candle;
rotating the article while applying the texture to the outer surface;
allowing for the texture to dry;
applying at least one coating of paint to the article;
rotating the article while apply a coating of paint;
allowing for said coating of paint to dry;
applying a coating of urethane; and
allowing for said coating of urethane to dry.

12. The method of claim 11 whereby the texture is applied to the article by a creator using small horizontal and vertical movements with a hot glue gun to mimic dripped candle wax.

13. The method of claim 11 whereby additional texture of hot melt adhesive is applied to the article once a previous application of texture has dried.

14. The method of claim 11 further comprising the step whereby the texture is rubbed down after application and drying.

15. The method of claim 11 further comprising the step whereby putty is strategically placed onto the texture to further enhance and mimic dripped candle wax.

16. The method of claim 11 further comprising the step of loading a paint dispenser with various colors of paints such that the various colors of paint are added in layers on top of each other in a strategic fashion to get a desired blending of said paint colors into new colors and application of said paint to said texture on said article applying the paint with the paint dispenser and rotating the article simultaneously.

17. The method of claim 16 further comprising the step of letting the painted article dry for a time period of three to five days after a coating of paint is applied and repeating the step of claim 16 as many times as desired by a creator to obtain a desired look.

18. The method of claim 1 further comprising the step of placing the article in the sun for at least three days to fully dry after a final coating of paint has been applied.

19. The method of claim 1 whereby the urethane coating is applied by dipping said elongated article into a vat filled with urethane and allowing the article to dry.

20. The method of claim 1 further comprising the step of applying a plurality of coatings of urethane to the article.
